(19) United States
(12) Patent Application Publication
(10) Pub. No.: US 2007/0094074 A1
(43) Pub. Date: Apr. 26, 2007

(54) Method and system for facilitating trading of digital media space

(75) Inventor: Guillermo Bodnar, Chantilly, VA (US)

Correspondence Address: Alfred W. Froebrich, Esq.;Cohen, Pontani, Lieberman & Pavane, Suite 1210, 551 Fifth Avenue, New York, NY, 10176, US

(73) Assignee: Arbinet-thexchange, Inc.

(21) Appl. No.: 11/409,758

(22) Filed: Apr. 24, 2006

Related U.S. Application Data
(60) Provisional application No. 60/729,922, filed on Oct. 25, 2005.

(51) Int. Cl. G06Q 30/00

(52) U.S. Cl. 705/14

(57) ABSTRACT

A system for trading media space includes a server node which receives requests for media space from buyers and offers of media space from sellers. The server node includes a set of rules for matching one of the requests and with a composite offer including a plurality of media spaces from a plurality of sellers which collectively meet the requirements of the one of the buyers. A delivery system is connected to said server node for facilitating delivery of media content between the buyer and seller of the matched pair.

### CROSS-REFERENCE TO RELATED APPLICATIONS

This application also claims priority from U.S. Provisional Patent Application Ser. No. 60/729,922 which was filed on Oct. 25, 2005.

### BACKGROUND OF THE INVENTION

The present invention relates to a method and a system for trading online media space and, more specifically, to an online system for trading online advertisements.

Historically, revenues generated from selling media space for advertising have represented an important source of income for media companies. Television and radio stations as well as many Web sites rely almost exclusively on advertising revenue to fund the cost of their operations so that they may provide programming and content free of charge to the general public. Similarly, general-interest newspapers and magazines depend on advertising revenues to subsidize their cost of operations, allowing them to offer their publications to the public at low prices or free of charge.

In recent years, the forums for advertising have become as creative as they are ubiquitous: from banners on the sides of buses to stickers on peels of fruit. In addition, online advertising on Internet pages is no longer considered an emerging technology. Rather, Internet advertisements are now considered on par with the more traditional newspaper, radio and television advertisements. Furthermore, advertisers are now considering many other digital media spaces such as, for example, digital TV, digital radio, online music services, portable media players, video games, and cellular phone screens.

Traditional systems and methods for buying and selling non-interactive media space are generally inefficient, in terms of time, human and capital resources employed. They are oftentimes ineffective in that they produce sub-optimal results or waste unsold inventory. The reasons for this relate to the fragmented structure of the industry: With thousands of geographically dispersed buyers and sellers, the customized nature of such transactions necessitates lengthy periods for contract negotiation and market discovery.

Related to this is the fact that the metrics by which traders determine the value of non interactive media space are of questionable statistical significance and can be a subject of dispute, thereby hindering the commoditization of media space and the efficiency of trading. Additionally, due to the inefficiencies described above, trading in noninteractive media is generally conducted well-before scheduled placement, relying on metrics that are dated and often inaccurate by the time the advertisements appear.

There have been attempts to provide technological solutions to facilitate more efficient and effective trading and placement of interactive media. U.S. Pat. No. 6,985,882 discloses a method and system for selling and purchasing media over a distributed communication network. This reference describes a media marketplace server with which media buyers and media sellers interact via a distributed communication network such as, for example, the Internet. U.S. Pat. No. 6,985,882 discloses that the media space seller is able to download advertising content from the advertiser or purchaser of the media space.

U.S. Application Publication No. 2002/0107787 discloses a method for facilitating trading of media spaces. According to this reference, a traded space intended for placement of an advertisement content may include one or more attributes including: type of medium, unit of trade, target market, time interval of placement, and audience characteristics. A server node receives and stores bids and asks from buyers and sellers of media space through interfaces such as computers, cellular phones, or personal digital assistants (PDAs). The server node matches bids according to rules and a clearinghouse module linked to the server node performs the clearing, settlement, billing and other related functions for an executed trade transaction.

Improvements to the known methods and systems for trading media space are still needed to take advantage of the various advertising opportunities presented by digital media spaces.

### SUMMARY OF THE INVENTION

An object of the present invention is to provide a method and system for facilitating flexible and efficient trading of digital media space.

According to an embodiment of the present invention, the system provides sellers of media space access to multiple buyers of media space in one electronic marketplace, thereby allowing sellers to maximize the value of their unsold inventory.

According to an embodiment of the present invention, a system for trading media space includes a server node which receives requests for media space from buyers and offers of media space from sellers and matches a request of one of the buyers with a composite offer to form a matched request and offer pair using a set of rules, the composite offer including a plurality of media spaces from a plurality of sellers which collectively meet the requirements of the one of the buyers. The buyers requests may be in the form of a free text search. The matching may include periodically performing a matching algorithm until the composite offer is found.

At least one of the plurality of media spaces from the plurality of sellers in the consolidated offer is a portion that is less than an entirety of one of said offers of media space from the sellers.

According to an embodiment of the present invention, a contents database receives the media content from the buyer when the request is submitted to the server node and stores the media content. The media content is then delivered from the contents database to the one of the sellers of the matched pair in response to said server node when a matched pair is formed. The contents database may also translate the media content from an originating format to a second format that is compatible with at least one of the sellers of the composite offer. The translation could alternatively be performed by the server node.

The media content may also be delivered directly from a first database of the one of the buyers of the matched pair to the sellers of the composite offer. This delivery may be initiated by the server node. The server node may also control caching of the media content on multiple servers to optimize delivery. The delivery may be performed automatically in response to the formation of the composite offer.

After delivery of the media content, the delivery of the media content to the seller and performance of the offer by the seller may be tracked by a mediation system.

The composite offer comprises at least two alternative composite offers, wherein one of the alternative composite offers is the most inexpensive composite offer that matches the buyers criteria. Alternatively, the composite offer may comprise only a single composite offer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a block diagram depicting a preferred embodiment of the present invention; and

FIG. 2 is a flow diagram depicting the steps according to the method of the present invention.

### DETAILED DESCRIPTION OF THE PRESENTLY PREFERRED EMBODIMENTS

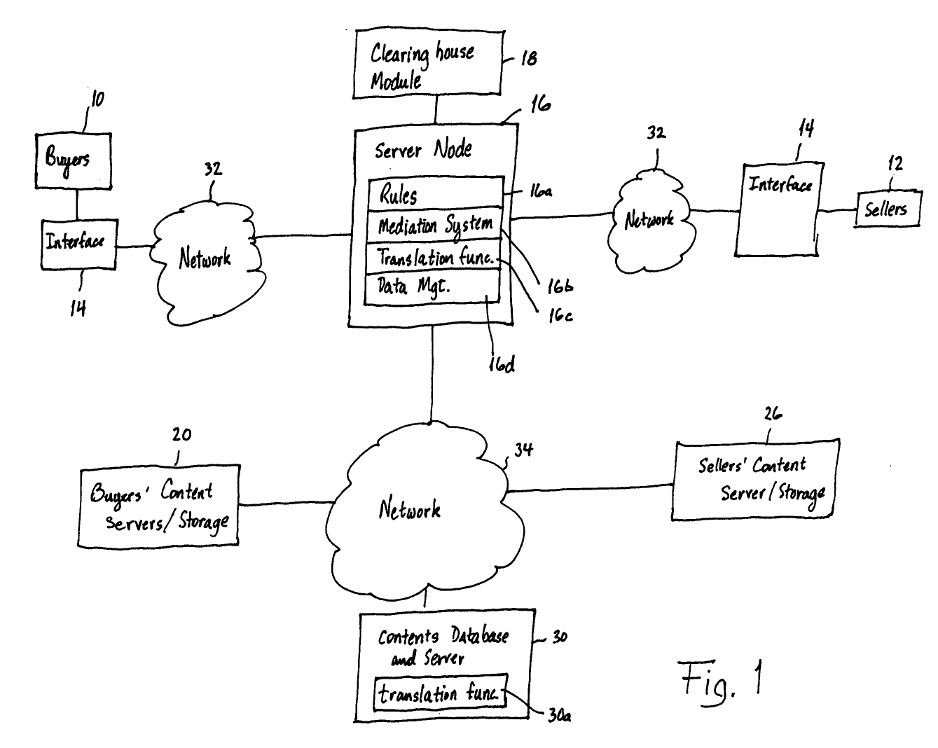

FIG. 1 is a block diagram of a system for trading media space according to an embodiment of the present invention. Market participants such as, for example, buyers 10 of media space and sellers 12 of media space interact with a server node 16 of the system using an interface 14 which may, for example, comprise a computer, a cellular phone, a personal digital assistant (PDA), or any other device capable of communication with the server node 16 via network 32 which may be wired or wireless. The interface 14 may communicate with the server node 16 via a private network, a wide area network (WAN) such as the Internet, or a combination thereof. The interface 14 includes an input channel such as a keyboard, electronic pen, voice recognition, or other input which allows the seller market participants to submit offers (i.e., asks) of media space the buyer market participants to submit requests (i.e., bids) for media space. The interface 14 also includes an output channel, such as a screen or a speaker for transmitting information regarding the status of the submissions to the participants. In a preferred embodiment, the media space to be traded is digital media space in, for example, Internet pages, digital TV, digital radio, online music services, portable media players, video games, cellular phone screens, and other Internet services. The media space may additionally include virtual space in virtual worlds such as video games and emusic.

The server node 16 receives and stores the bid and ask information submitted by the participants which may, for example, include the type of media space to be traded, the unit of the trade, quantity of the unit, the target market of the media space, time interval of placement, expected or guaranteed audience characteristics, rate, content delivery information, and information regarding the market participant responsible for the bid and ask. The server node 16 includes a memory with a set of rules 16a which includes requirements and procedures for participation in the electronic market such as, for example, the required method for submitting the offer and requests, deal making processes, deal execution criteria, and delivery options for delivery of the media from the advertiser to the media space owner. The bids and asks may be validated by the server node 16 using known authentication procedures. Submissions are entered into an active bid/ask database which may be a part of the memory storing the set of rules 16a, the contents of which may be viewed by the participants. In a process described in more detail below, the server node 16 matches the bids and asks based on the parameters specified in the bids and asks which satisfy deal execution requirements set forth in the set of rules 16a. Confirmation of executed deals is sent to the participants and the deal information is recorded in a database. A clearinghouse module 18 is linked to the server node 16 and performs clearing, settlement, billing and other related back office functions on behalf of the parties for each executed trade transaction. The server node 16 may include a mediation system 16b connected to the sellers' content servers/storage 26 which receives feedback used to monitor trade execution, delivery, and performance. The mediation system may also post quality metrics and confirm the delivery and distribution of advertising content and the availability of media spaces.

The server node 16 also facilitates the delivery of the media content from the buyer of media space to the correspondingly matched seller of media space after execution of a trade between the two parties. For this purpose, the server node 16 is connected to buyers' content storage facilities 20 and sellers' content storage facilities 26. The server node 16 may also be connected to a contents database and server 30 by a network 34. A data management module 16d optimizes delivery of the content by caching the content on the buyers' content storage facilities 20, the sellers' content storage facilities 26, and the contents database and server 30. The buyers' content storage facilities 20 and the sellers' content storage facilities 26 are connected to the contents database and server 30 through the network 34 which may, for example, comprise a Wide Area Network (WAN) such as the Internet or a Local Area Network (LAN), an IP network, an e-mail system, or other file transfer means. Furthermore, a translation module 16c of the server node 16 may be used to translate the content from an originating format to another format that is compatible with the seller receiving the content.

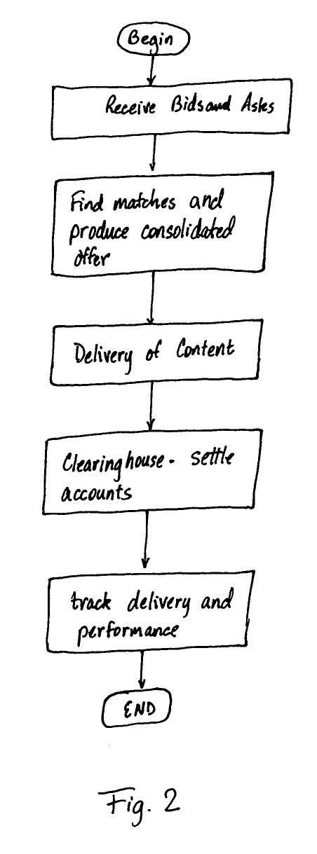

FIG. 2 shows the steps of a method according to an embodiment of the present invention. The bids and asks are first received from the buyers and sellers at the server node 16 in step 100. The media buyers' bids can specify a trading profile that defines the attributes they are looking for such as but not limited to: market, radius, preferred dates and times, number of repetitions, Gross Rating Points (GRPs), Cost per thousand impressions (CPM), program, ratings, as well as target demographics and optionally the preferred media and expected quality. Media buyers can opt to specify a free text search criteria that best identifies the target media and audience. For instance, buyers can specify as part of the matching criteria only to match to available media spaces that are related to “College” and “Football”.

Sellers can use machine to machine interfaces or human interfaces to load up their media space inventories into the trading system. The media space contemplated for trading may include one or more of the following attributes input by the seller: type of medium; unit of trade; target market; time interval of placement; and audience characteristics.

Once a buyer's bid is received, the server node 16 searches an available inventory of media spaces from the sellers. Using optimization algorithms, the server node 16 identifies the available media spaces that best fit the criteria of the buyer and present to the buyer a single consolidated offer, based on the criteria of the bid, step 102. In this way, a great level of efficiency is achieved by combining multiple fragmented offering from more than one seller. The optimization algorithm may also generate alternative consolidated offers, each emphasizing a different attribute. For example, a first consolidated offer may provide the most cost efficient offer that meets the criteria and a second consolidated offer may provide the offer that reaches the most people in a target audience, based on statistics of the seller's inventories. Once an offer is accepted by the buyer, the server node 16 updates the inventory. If a buyer does not accept any of the offers or no offers are available that match the bid, step 102 may be repeated periodically until an acceptable offer is found or until a time limit of the bid is reached.

At step 104, the media content is delivered from the buyer to the seller. Automatic delivery of the content from the buyer to the seller allows the match to be a near-to-event transaction. That is, the match can be made in a spot market immediately prior to when the ad will be displayed. Buyers desiring the system to facilitate automatic delivery of content upon execution of trades may send the offered media content to the contents database and server 30 when a bid is made. Upon acceptance of matched offer, the server 16 instructs the contents database and server 30 to send the media content to the content server/storage 26 of a matched seller or sellers. In this alternative embodiment, the content of the advertisement from the buyer of media space is automatically delivered to the seller of media space upon completion of the trade. It is also possible for the seller to provide information to be stored in the contents database and server 30 before the match is made, i.e., a URL to which the content may be sent.

In an alternative embodiment, the server node 16 may inform the participants of the completed trade and provide information to the buyer which allows the buyer in the settled trade to directly send the content to the seller or sellers of the settled trade. In this embodiment, the server node 16 merely coordinates the transfer of content and does not actually perform the automatic delivery. The server node 16 and/or the contents database and server 30 may also provide a translation function 16c, 30a which translates an originating format of the advertising content into a format compatible with the sellers media space. Various audio and video formats are available for media. Buyers of media content may produce content in a format that is not compatible or readable by certain sellers. In this embodiment, the seller's offer includes an indication of the compatible formats. Before forwarding the content to the seller, the server node 16 and/or the contents database and server 30 translates the content, if required. This way the seller of the media space is not required to translate the content at the seller's end.

The clearinghouse module 18 receives information regarding the accepted offer from a mediation system 16b in the server node 16 and adjusts the accounts of each of the sellers involved, step 106. The buyer is presented with one consolidated bill for the entire transaction. The clearinghouse module 18 receives real time information about settled deals from the mediation system 16b and can therefore provide credit risk management and overall quality control of the process.

The mediation system 16b of the server node 16 is connected to the sellers' content servers/storage 26 and receives feedback used to monitor trade execution, delivery, and performance of the matched trades, step 108. The mediation system 16b may post quality metrics and confirmation of the delivery, distribution, and available media spaces. Thus the mediation system 16b may be used to track performance of sellers after the matched trades are agreed upon. The feedback may be compared to a seller's original ask and the results may be used to determine whether the seller's information about target audience and other statistical attributes was correct. Buyers may then in the future check whether a particular seller has met the requirements of his previous trades.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for trading media space, comprising:
a server node operatively connectable to user interfaces for receiving requests for media space from buyers and offers of media space from sellers, said server comprising a memory with a set of rules for matching one of the requests with a composite offer to form a matched request and offer pair, the composite offer including a plurality of media spaces from a plurality of sellers which collectively meet the requirements of the buyers; and
a delivery system connected to said server node for facilitating delivery of media content between the buyer and seller of the matched request and offer pair.

2. The system of claim 1, wherein at least one of the plurality of media spaces from the plurality of sellers in the consolidated offer is a portion that is less than an entirety of one of said offers of media space from the sellers.

3. The system of claim 1, further comprising a buyer's content database and a seller's content database, wherein said server node is connectable to said buyer's content database and to said seller's content database by a non-dedicated bandwidth.

4. The system of claim 3, further comprising a contents database including means for receiving the media content from the buyer when the request is submitted to the server node and storing the media content in the contents database, and means for automatically delivering the media content from the contents database to the one of the sellers of the matched pair in response to said server node.

5. The system of claim 3, wherein said server node includes means for initiating delivery of the media content from the buyer to the seller.

6. The system of claim 3, wherein said delivery system comprises a data management module for optimizing delivery of the media content by caching the media content on multiple servers.

7. The system of claim 1, wherein the buyers request is in the form of a free text search.

8. The system of claim 1, wherein said delivery system further distributes the media content through data transfer means.

9. The system of claim 8, wherein the data transfer means includes applications including at least one of email and office.

10. The system of claim 1, wherein said composite offer comprises at least two alternative composite offers.

11. The system of claim 10, wherein one of the alternative composite offers is the most inexpensive composite offer that matches the buyers criteria.

12. The system of claim 1, wherein said composite offer comprises only a single composite offer.

13. The system of claim 1, further comprising a mediation system connectable to a seller for tracking delivery of the media content to the seller and performance of the offer by the seller.

14. A method for trading media space, comprising the steps of:
receiving, at a server node, requests for media space from buyers and offers of media space from sellers; and
matching a request of one of the buyers with a composite offer to form a matched request and offer pair using a set of rules, the composite offer including a plurality of media spaces from a plurality of sellers which collectively meet the requirements of the one of the buyers.

15. The method of claim 14, wherein at least one of the plurality of media spaces from the plurality of sellers in the consolidated offer is a portion that is less than an entirety of one of said offers of media space from the sellers.

16. The method of claim 14, further comprising the steps of receiving, by a contents database, the media content from the buyer when the request is submitted to the server node and storing the media content in the contents database, and automatically delivering the media content from the contents database to the one of the sellers of the matched pair in response to said server node.

17. The method of claim 16, further comprising the step of translating, at the contents database, the media content from an originating format to a second format that is compatible with at least one of the sellers of the composite offer.

18. The method of claim 14, further comprising the step of delivering the media content from a first database of the one of the buyers of the matched pair to the sellers of the composite offer.

19. The method of claim 18, wherein said step of delivering comprises, initiating, by the server node, delivery of the media content from the buyer to the seller.

20. The method of claim 18, wherein said step of delivering comprises caching the media content on multiple servers.

21. The method of claim 18, wherein said step of delivering is performed automatically in response to the composite offer comprises only a single composite offer.

22. The method of claim 18, further comprising the steps of tracking delivery of the media content to the seller and performance of the offer by the seller.

23. The method of claim 14, wherein the buyers request is in the form of a free text search.

24. The method of claim 14, wherein the composite offer comprises at least two alternative composite offers.

25. The method of claim 24, wherein one of the alternative composite offers is the most inexpensive composite offer that matches the buyers criteria.

26. The method of claim 14, wherein the composite offer comprises only a single composite offer.

27. The method of claim 14, further comprising the step of translating the media content from an originating format to a second format that is compatible with at least one of the sellers of the composite offer.

28. The method of claim 14, wherein said step of matching comprises periodically performing a matching algorithm until the composite offer is found.
